(19) United States
(12) Patent Application Publication
(10) Pub. No.: US 2017/0298673 A1
(43) Pub. Date: Oct. 19, 2017

(54) CONTROL APPARATUS

(71) Applicant: ALPS ELECTRIC CO., LTD., Tokyo (JP)

(72) Inventor: Shinji Mochida, Miyagi-ken (JP)

(21) Appl. No.: 15/476,335

(22) Filed: Mar. 31, 2017

(30) Foreign Application Priority Data
Apr. 15, 2016 (JP) 2016-082076

(51) Int. Cl. E05F 15/60; H02P 7/03

(52) U.S. Cl. CPC E05F 15/60; H02P 7/03; E05Y 2900/548; E05Y 2900/531; E05Y 2400/52; E05Y 2400/45; E05Y 2201/434; E05Y 2900/55; E05Y 2400/85

(57) ABSTRACT

A control apparatus includes: a submersion signal acquisition unit that acquires a submersion signal representing a situation of submersion switch; a power supply unit that supplies power to a drive unit that drives an opening and closing unit such that the opening and closing unit is opened and closed using the supplied power; an operation detection unit that detects an operation instructing the drive unit to perform driving such that the opening and closing unit is opened; and a control unit that controls the supplying of power to the power supply unit performed by the power supply unit on a basis of the submersion signal and the operation.

### CLAIM OF PRIORITY

This application claims benefit of priority to Japanese Patent Application No. 2016-082076 filed on Apr. 15, 2016 which is hereby incorporated by reference in its entirety.

### BACKGROUND

### 1. Field of the Disclosure

The present disclosure relates to a control apparatus.

### 2. Description of the Related Art

A configuration including potential switching control means in a drive apparatus is known (for example, see Japanese Unexamined Patent Application Publication No. 2001-341531).

In the drive apparatus disclosed in Japanese Unexamined Patent Application Publication No. 2001-341531, electrolytic corrosion is prevented by a circuit configuration within a switch. Since a circuit that functions when a vehicle is submerged is included in a switch circuit, the number of components of a circuit within the switch needs to be increased.

### SUMMARY OF THE INVENTION

An apparatus includes: a submersion signal acquisition unit that acquires a submersion signal representing a situation of submersion; a power supply unit that performs supplying of power to a drive unit that drives an opening and closing unit such that the opening and closing unit is opened and closed using the supplied power; an operation detection unit that detects an operation instructing the drive unit to perform driving such that the opening and closing unit is opened; and a control unit that controls the supplying of power to the drive unit which is performed by the power supply unit on a basis of the submersion signal and the operation.

### BRIEF DESCRIPTION OF THE DRAWINGS

FIG. 1 is a diagram illustrating examples of a drive unit, an opening and closing unit, and an emergency switch of a first embodiment;

FIG. 2 is a diagram illustrating an exemplary configuration of a control apparatus of the first embodiment;

FIG. 3 is a diagram illustrating an exemplary circuit configuration according to the first embodiment;

FIG. 4 is a diagram illustrating exemplary operations performed by the control apparatus of the first embodiment; and

FIG. 5 is a diagram illustrating exemplary operations performed in the case where the control apparatus of the first embodiment has detected an operation.

### DESCRIPTION OF THE EXEMPLARY EMBODIMENTS

### First Embodiment

Hereinafter, a control apparatus 1 of a first embodiment will be described with reference to the drawings.

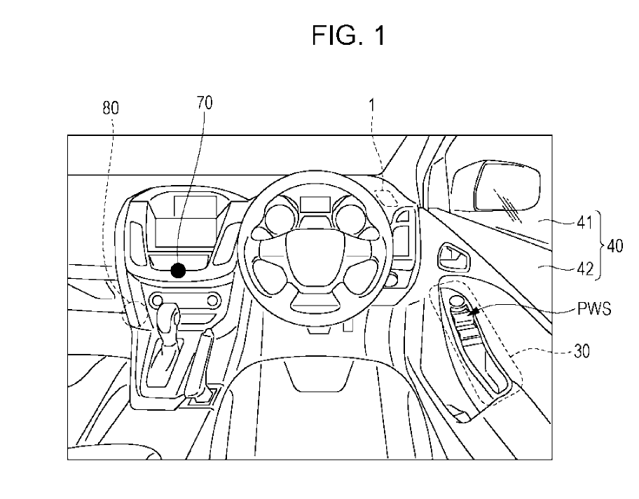

FIG. 1 is a diagram illustrating examples of a drive unit, an opening and closing unit, and an emergency switch.

Note that the number of configuration components described in this embodiment and their relative arrangement and the like are only examples for the purpose of description and are not intended to limit the scope of the present invention unless specifically described.

Schematic Configuration

Referring to FIG. 1, the control apparatus 1 is provided in a vehicle such as an automobile. This vehicle includes the control apparatus 1, a drive unit 30, an opening and closing unit 40, an emergency switch 70, and a submersion sensor 80.

Examples of the opening and closing unit 40 include a power window 41, and a door 42 that opens and closes electrically. Hereinafter, description will be made of a case where the opening and closing unit 40 is the power window 41.

The drive unit 30 includes a power window switch PWS and a motor (not illustrated). When the power window switch PWS is operated, the drive unit 30 drives the motor and opens and closes the opening and closing unit 40, i.e., the power window 41. The motor is driven by power supplied from a power supply such as a battery BAT (not illustrated) mounted in a vehicle.

The emergency switch 70 is provided, for example, at the center console of a vehicle and is operated by a vehicle occupant such as a driver.

The submersion sensor 80 outputs a submersion signal WS1 representing whether or not the vehicle is submerged.

Note that the positions where the control apparatus 1, the drive unit 30, the opening and closing unit 40, the emergency switch 70, and the submersion sensor 80 are provided are not limited to the illustrated positions.

Function Configuration

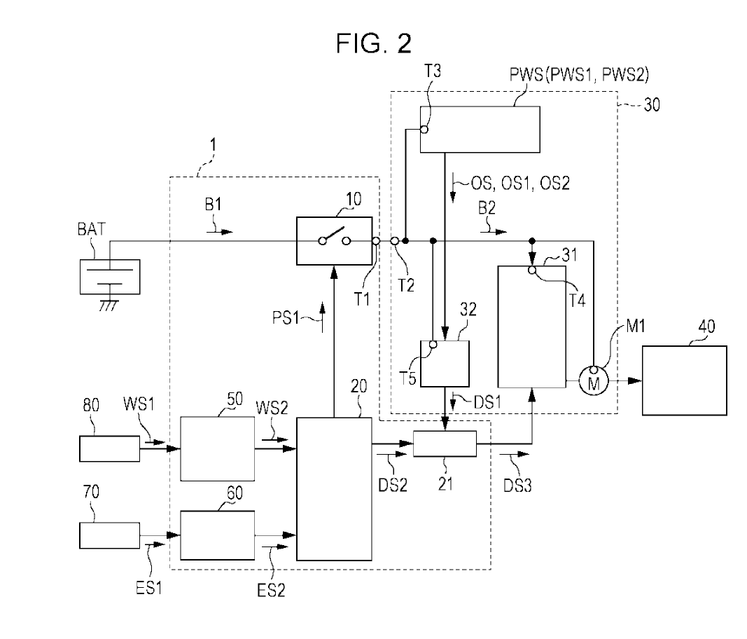

Referring to FIG. 2, the functional configuration of the control apparatus 1 and the drive unit 30 described above will now be described.

FIG. 2 is a diagram illustrating an exemplary configuration of a control apparatus of the first embodiment. The control apparatus 1 includes a power supply unit 10, a control unit 20, a drive signal control unit 21, a submersion signal acquisition unit 50, and an operation detection unit 60. The battery BAT, the emergency switch 70, and the submersion sensor 80 are connected to the control apparatus 1.

The submersion sensor 80 is disposed at a position that is submerged when the vehicle is submerged. The submersion sensor 80 includes a water detection device (not illustrated) detecting water and outputs the detection result of this water detection device as the submersion signal WS1.

The submersion signal acquisition unit 50 acquires the submersion signal WS1 output by the submersion sensor 80 and outputs the acquired submersion signal WS1 to the control unit 20 as the submersion signal WS2.

The emergency switch 70 is disposed at a position which enables a driver of the vehicle to operate the emergency switch 70 while sitting in the driver's seat. The emergency switch 70 detects an operation by the driver and outputs the detection result to the control unit 20 as an operation signal ES1.

The operation detection unit 60 receives the operation signal ES1 output by the emergency switch 70 and outputs the received operation signal ES1 to the control unit 20 as an operation signal ES2.

The control unit 20 is connected to the submersion signal acquisition unit 50, the operation detection unit 60, the power supply unit 10, and the drive signal control unit 21. The control unit 20 controls the state of the power supply unit 10 on the basis of the submersion signal WS2 output by the submersion signal acquisition unit 50 and the operation signal ES2 output by the operation detection unit 60.

Specifically, the control unit 20 outputs a power supply control signal PS1 to the power supply unit 10. The power supply control signal PS1 is a signal that controls on and off of power supplied by the power supply unit 10. The control unit 20 controls on and off of supply of the power B1 from the power supply unit 10 to the drive unit 30 by outputting the power supply control signal PS1.

More specifically, when the submersion signal WS2 represents “not submerged”, the control unit 20 performs control such that the power B1 is supplied to the drive unit 30 from the power supply unit 10 irrespective of the state of the operation signal ES2. In other words, the power supply unit 10 is controlled so as to be in the “on” state by the control unit 20 when the submersion signal WS2 represents “not submerged”.

When the submersion signal WS2 represents “submerged”, the control unit 20 performs control such that the power B1 is to be supplied to the drive unit 30 or stopped in accordance with the state of the operation signal ES2.

Specifically, the control unit 20 stops supply of the power B1 from the power supply unit 10 to the drive unit 30 when the submersion signal WS2 represents “submerged” and the operation signal ES2 represents “no operation”. In other words, in this case, the power supply unit 10 is controlled so as to be in the “off” state by the control unit 20.

The control unit 20 supplies the power B1 from the power supply unit 10 to the drive unit 30 when the submersion signal WS2 represents “submerged” and the operation signal ES2 represents “operation performed”. In other words, in this case, the power supply unit 10 is controlled so as to be in the “on” state by the control unit 20.

Further, the control unit 20 controls the state of the drive signal control unit 21 on the basis of the submersion signal WS2 output by the submersion signal acquisition unit 50 and the operation signal ES2 output by the operation detection unit 60.

The drive signal control unit 21 is connected to the control unit 20 and the drive unit 30. The drive signal control unit 21 outputs a drive signal DS3 on the basis of a drive signal DS2 output by the control unit 20 and a drive signal DS1 output by the drive unit 30.

Control of the drive signal control unit 21 by the control unit 20 will be specifically described. The control unit 20 outputs the drive signal DS2 to the drive signal control unit 21 on the basis of the submersion signal WS2 and the operation signal ES2. The drive signal DS2 is a signal for driving the power window 41 to open.

Here, the control unit 20 does not output the drive signal DS2 when the submersion signal WS2 represents “not submerged” and the operation signal ES2 represents “no operation”. In other words, the control unit 20 does not drive the power window 41 in this case.

The control unit 20 does not output the drive signal DS2 when the submersion signal WS2 represents “not submerged” and the operation signal ES2 represents “operation performed”. In other words, the control unit 20 does not drive the power window 41 in this case.

The control unit 20 does not output the drive signal DS2 when the submersion signal WS2 represents “submerged” and the operation signal ES2 represents “no operation”. In other words, the control unit 20 does not drive the power window 41 in this case.

The control unit 20 outputs the drive signal DS2 when the submersion signal WS2 represents “submerged” and the operation signal ES2 represents “operated”. In other words, the control unit 20 drives the power window 41 to open.

In other words, when the submersion signal WS2 represents “not submerged”, the control unit 20 does not drive the power window 41 irrespective of the state of the operation signal ES2. Further, when the operation signal ES2 represents “no operation”, the control unit 20 does not drive the power window 41 irrespective of the state of the submersion signal WS2.

When the submersion signal WS2 represents “submerged” and the operation signal ES2 represents “operation performed”, the control unit 20 drives the power window 41 to open.

In other words, the control unit 20 performs control of outputting the drive signal DS2 or control of not outputting the drive signal DS2 on the basis of the state of the submersion signal WS2 and the state of the operation signal ES2.

The drive signal control unit 21 outputs, as the drive signal DS3, the drive signal DS1 output by the drive unit 30 as is when the drive signal DS2 is not being output from the control unit 20. Specifically, when the drive signal DS2 is not being output, the drive signal control unit 21 outputs the drive signal DS3 representing “driving for opening” when the drive signal DS1 represents “driving for opening”. Further, when the drive signal DS2 is not being output, the drive signal control unit 21 outputs the drive signal DS3 representing “driving for closing” when the drive signal DS1 represents “driving for closing”.

When the drive signal DS2 is being output, the drive signal control unit 21 outputs the drive signal DS3 representing “driving for opening” irrespective of the state of the drive signal DS1.

In other words, when the drive signal DS2 is being output, the drive signal control unit 21 preferentially outputs a signal as the drive signal DS3, in accordance with the instruction of the drive signal DS2 rather than the instruction of the drive signal DS1.

Now, the function configuration of the drive unit 30 will be described. The drive unit 30 includes the power window switch PWS, a relay 31, a micro control unit (MCU) 32, and a motor M1.

The drive unit 30 receives the power B1 supplied from a terminal T1 provided in the power supply unit 10 as power B2, at a terminal T2 provided in the drive unit 30. The power B2 is supplied to a terminal T3 provided in the power window switch PWS. The power B2 is supplied to a terminal T4 provided in the relay 31. The power B2 is supplied to a terminal T5 provided in the MCU 32.

The power window switch PWS outputs to the MCU 32 an operation signal OS corresponding to an operation performed by an occupant of the vehicle. The power window switch PWS includes a power window switch PWS1 operated when the power window 41 is to be opened and a power window switch PWS2 operated when the power window 41 is to be closed. The power window switch PWS1, when operated, outputs an operation signal OS1 representing “opening operation” for opening the power window 41. The power window switch PWS2, when operated, outputs an operation signal OS2 representing “closing operation” for closing the power window 41.

The MCU 32, which includes, for example, a micro computer, converts the operation signal OS output by the power window switch PWS into the drive signal DS1 and outputs the converted drive signal DS1 to the drive signal control unit 21.

The relay 31 supplies the power B2 supplied from the power supply unit 10 to the terminal (not illustrated) of the motor M1, on the basis of the drive signal DS3 output by the drive signal control unit 21. The relay 31 supplies power for opening the power window 41 to the motor M1 when the drive signal DS3 represents “driving for opening”. The relay 31 supplies power for closing the power window 41 to the motor M1 when the drive signal DS3 represents “driving for closing”.

The motor M1 operates in accordance with the relay 31. The motor M1 drives the power window 41 to open and close.

Note that the power window 41 described here is an example of a “window” serving as the opening and closing unit 40. The opening and closing unit 40 is not limited to the power window 41. The opening and closing unit 40 may be the door 42 opened and closed by the drive unit 30. The door 42 is an example of the “door” serving as the opening and closing unit 40. The opening and closing unit 40 may be a power slide door (not illustrated), the door (not illustrated) of a trunk, or a door lock (not illustrated) that fits the striker of the door.

Circuit Configuration of the First Embodiment

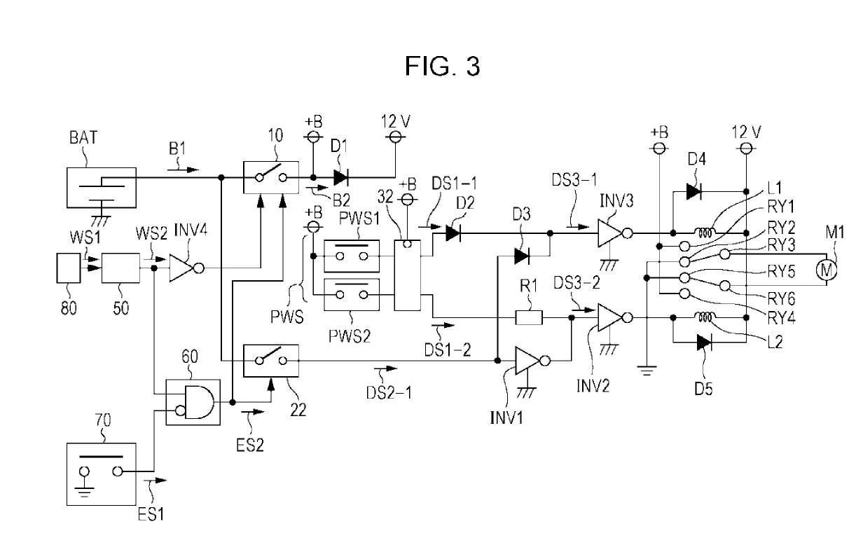

Next, referring to FIG. 3, an exemplary circuit configuration according to the first embodiment will be described. FIG. 3 is a diagram illustrating an example of the circuit configuration of the control apparatus of the first embodiment. Note that the circuit configuration illustrated in FIG. 3 is an example, and the circuit configuration of the control apparatus is not limited to this.

The battery BAT is connected to the power supply unit 10 and a drive signal generation unit 22. The power supply unit 10 supplies the power B1 supplied from the battery BAT as the power B2. The power B2 corresponds to power +B. Further, the power B2 is supplied as 12V power through a diode D1.

The power +B is supplied to the power window switch PWS1 and the power window switch PWS2. The power window switch PWS1 and the power window switch PWS2 are each connected to the MCU 32.

A diode D4, a diode D5, a relay coil L1, a relay coil L2, a relay terminal RY1, a relay terminal RY2, a relay terminal RY3, a relay terminal RY4, a relay terminal RY5, and a relay terminal RY6 are components included in the relay 31.

The power +B and power +12V are supplied to the relay 31. The relay 31 is connected to the motor M1. The relay 31 drives the motor M1 by using the supplied power +B.

The motor M1 drives the power window 41 to open and close.

A diode D3, a resistor R1, and an inverter INV1 are components included in the drive signal control unit 21.

When a current flows through the relay coil L1 as a result of a potential difference being generated across the two ends of the relay coil L1 and a current does not flow through the relay coil L2 since a potential difference is not generated across the two ends of the relay coil L2, the motor M1 operates to drive the power window 41 to open. Specifically, when the relay terminal RY1 and the relay terminal RY3 are connected to each other and the relay terminal RY5 and the relay terminal RY6 are connected to each other, the motor M1 operates to drive the power window 41 to open.

When a potential difference is not generated between the two terminals of the relay coil L1 and a current does not flow, and a current is made to flow as a result of a potential difference being generated across the two ends of the relay coil L2, the motor M1 operates such that the power window 41 is driven so as to be closed. Specifically, when the relay terminal RY2 and the relay terminal RY3 are connected to each other and the relay terminal RY4 and the relay terminal RY6 are connected to each other, the motor M1 operates such that the power window 41 is driven so as to be closed.

An MCU 32 outputs the drive signal DS1-1 on the basis of operation of the power window switch PWS1. The MCU 32 outputs a drive signal DS1-2 on the basis of operation of the power window switch PWS2.

The drive signal DS1-1 is supplied to the relay coil L1 as a drive signal DS3-1 through the drive signal control unit 21. The drive signal DS1-2 is supplied to the relay coil L2 as a drive signal DS3-2 through the drive signal control unit 21.

The relay 31 drives the motor M1 on the basis of the drive signal DS3-1 and the drive signal DS3-2.

The submersion sensor 80 is connected to the submersion signal acquisition unit 50. The submersion sensor 80 outputs the submersion signal WS1 to the submersion signal acquisition unit 50.

The submersion signal acquisition unit 50 is connected to an inverter INV4 and the operation detection unit 60. The submersion signal acquisition unit 50 acquires the submersion signal WS1. The submersion signal acquisition unit 50 outputs the submersion signal WS2 to the inverter INV4. Further, the submersion signal acquisition unit 50 outputs the submersion signal WS2 to the operation detection unit 60.

The inverter INV4 is connected to the power supply unit 10. The inverter INV4 acquires the submersion signal WS2. When the inverter INV4 acquires the submersion signal WS2, the power supply unit 10 stops supply of the power B2.

The operation detection unit 60 is connected to the submersion signal acquisition unit 50, the emergency switch 70, the power supply unit 10, and the drive signal generation unit 22 that is included in the control unit 20.

The emergency switch 70, when operated, outputs an operation signal ES1 to the operation detection unit 60.

The operation detection unit 60 acquires the submersion signal WS2 from the submersion signal acquisition unit 50. The operation detection unit 60 acquires the operation signal ES1 from the emergency switch 70. The operation detection unit 60 acquires the submersion signal WS2 and, when the operation signal ES1 is acquired, outputs the operation signal ES2 to the power supply unit 10 and the drive signal generation unit 22.

The power supply unit 10 restarts supply of the power B2 upon acquisition of the operation signal ES2.

The drive signal generation unit 22, upon acquisition of the operation signal ES2, outputs a drive signal DS2-1. The drive signal DS2-1 is a signal by which the power window 41 is driven so as to be opened.

The operation detection unit 60 outputs the operation signal ES2 as a result of a logical AND of the submersion signal WS2 and the inverted operation signal ES1. Specifically, the operation detection unit 60 restarts supplying of power from the power supply unit 10 to the drive unit 30 on the basis of the submersion signal WS2 and the operation signal ES1. Further, the drive signal generation unit 22 generates the drive signal DS2-1 on the basis of the operation signal ES2. In other words, when the submersion sensor 80 detects a submerged state and the emergency switch 70 is operated, the control apparatus 1 restarts supplying of power to the drive unit 30 and generates the drive signal DS2-1 for opening the power window 41.

Here, when the submersion sensor 80 has not detected submersion, there may be a case in which it is not preferable that the power window 41 be driven by the control apparatus 1 so as to be opened even when the emergency switch 70 is operated. In other words, there may be a case in which it is desired that the emergency switch 70 be operable only when the vehicle is submerged. In a state in which the submersion sensor 80 has not detected submersion, even when the emergency switch 70 is operated, the power window 41 is not driven by the control apparatus 1 so as to be opened. According to the control apparatus 1 configured like this, the emergency switch 70 can be made to be operable only when the vehicle is submerged.

In the case where the drive signal DS2-1 is not supplied from the drive signal generation unit 22, the drive signal control unit 21 supplies the drive signal DS1-1 supplied from the MCU 32 as is, as the drive signal DS3-1. In the case where the drive signal DS2-1 is not supplied from the drive signal generation unit 22, the drive signal control unit 21 supplies the drive signal DS1-2 supplied from the MCU 32 as is, as the drive signal DS3-2.

In the case where the submersion sensor 80 has detected submersion, the drive signal control unit 21, irrespective of the state of the drive signal DS1-1, outputs the drive signal DS2-1 as the drive signal DS3-1. The drive signal control unit 21, irrespective of the state of the drive signal DS1-2, outputs the drive signal DS2-1 inverted by the inverter INV-1 as the drive signal DS3-1.

The drive signal DS3-1 and the drive signal DS3-2 in the case where the drive signal DS2-1 is being supplied from the drive signal generation unit 22 are signals for driving the power window 41 to open.

In other words, the control apparatus 1 can drive the power window 41 to open by supplying the drive signal DS2-1 irrespective of the state of the power window switch PWS.

Note that, although not essential in the first embodiment, the power supply unit 10, the submersion signal acquisition unit 50, the operation detection unit 60, and the control unit 20 may be provided in a non-submerged region.

Example Operations Performed by the Control Apparatus 1 According to the First Embodiment

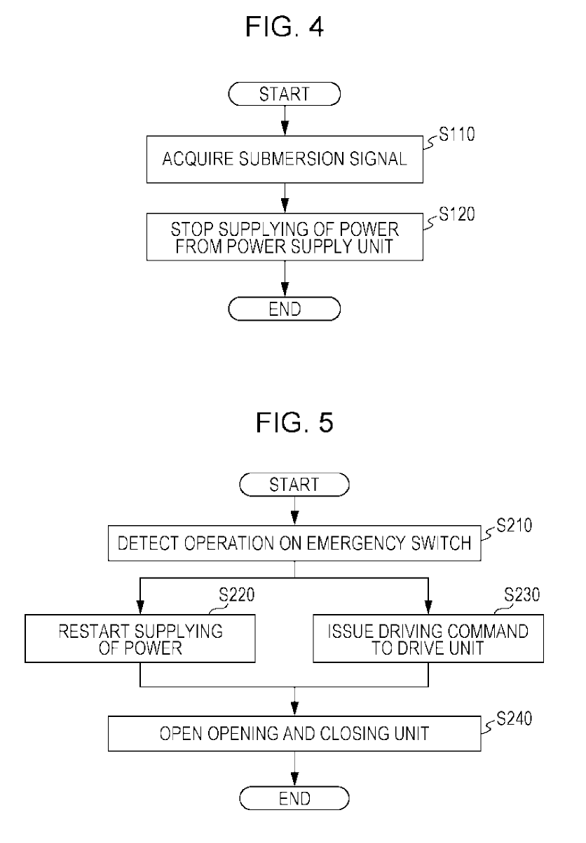

Next, operations performed at the time when the control apparatus 1 has detected the submersion signal WS1 will be described with reference to FIG. 4.

FIG. 4 is a diagram illustrating exemplary operations performed by the control apparatus of the first embodiment.

The submersion signal acquisition unit 50 acquires the submersion signal WS1 (step S110). When the submersion signal acquisition unit 50 acquires the submersion signal WS1, the control unit 20 stops supply of the power B2 from the power supply unit 10 to the drive unit 30 (step S120).

Next, referring to FIG. 5, exemplary operations performed in the case where the control apparatus 1 has detected the operation signal ES1 will be described.

FIG. 5 is a diagram illustrating exemplary operations performed in the case where the control apparatus of the first embodiment has detected an operation.

The operation detection unit 60 detects the operation signal ES1 showing that the emergency switch 70 has been operated (step S210). The control unit 20 restarts supply of the power B2 from the power supply unit 10 to the drive unit 30 on the basis of the submersion signal WS2 and the operation signal ES2 (step S220). Further, the control unit 20, on the basis of the submersion signal WS2 and the operation signal ES2, issues an instruction to the drive unit 30 to drive the opening and closing unit 40 to open (step S230). Note that either of step S220 and step S230 may be started first. The drive unit 30, upon receipt of an instruction for opening from the control unit 20, drives the opening and closing unit 40 to open (step S240).

As described above, when the submersion signal acquisition unit 50 acquires the submersion signal WS1, the control apparatus 1 stops supply of the power B2 from the power supply unit 10 to the drive unit 30. Further, the control apparatus 1, when detecting that the emergency switch 70 has been operated, restarts supply of the power B2 from the power supply unit 10 to the drive unit 30.

Hence, according to the control apparatus 1, subsequent to submersion and before the emergency switch 70 is operated, supply of the power B2 from the power supply unit 10 is stopped. As a result, according to the control apparatus 1, during a period after submersion and before the emergency switch 70 is operated, electrolytic corrosion of the relay 31, the MCU 32, and the terminals and contacts of the power window switch PWS included in the drive unit 30 is suppressed.

Further, the control apparatus 1 collectively performs restarting supply of the power B2 from the power supply unit 10 and driving of the power window 41 for opening through operation of the single emergency switch 70. Hence, in an emergency such as submerging, the control apparatus 1 can drive the opening and closing unit 40 to open through operation of a single switch, so that the occupants may escape from the vehicle.

The control apparatus 1 puts control performed by the control unit 20 before control performed by the MCU 32 of the drive unit 30. Specifically, when the control unit 20 is outputting the drive signal DS2 representing driving for opening of the opening and closing unit 40, the control apparatus 1 drives the opening and closing unit 40 to open, irrespective of operation of the power window switch PWS. Hence, according to the control apparatus 1, even when operation of closing the power window 41 is performed using the power window switch PWS at the time when the vehicle is submerged, the power window 41 can be forcibly driven so as to be opened through operation of the emergency switch 70.

Here, in existing technologies, a circuit for preventing electrolytic corrosion may be provided within a switch to suppress electrolytic corrosion in the case where a vehicle is submerged. According to an existing technology with such a configuration, the switch is increased in size.

On the other hand, according to the control apparatus 1 of the present embodiment, electrolytic corrosion at the time when a vehicle is submerged can be suppressed without increasing the number of components in the switch.

The embodiments of the present have been described in detail with reference to the drawings. The specific configurations are not limited to those in the present embodiments and may be appropriately changed without departing from the scope of the present invention.

What is claimed is:

1. A control apparatus comprising:
a submersion signal acquisition unit that acquires a submersion signal representing a submersion situation;
a power supply unit that performs supplying power to a drive unit that drives an opening and closing unit such that the opening and closing unit is opened and closed using the supplied power;
an operation detection unit that detects an operation instructing the drive unit to perform driving such that the opening and closing unit is opened; and
a control unit that controls the supplying of power to the drive unit which is performed by the power supply unit on a basis of the submersion signal and the operation.

2. The control apparatus according to claim 1,
wherein the control unit stops supplying power to the drive unit on a basis of the submersion signal acquired by the submersion signal acquisition unit.

3. The control apparatus according to claim 2,
wherein the control unit, on a basis of the operation detected by the operation detection unit, restarts supplying power to the drive unit and outputs a drive signal for driving the opening and closing unit such that the opening and closing unit is opened.

4. The control apparatus according to claim 3, wherein the control unit, further on a basis of the submersion signal, restarts supplying power to the drive unit and outputs to the drive unit the drive signal for driving the opening and closing unit such that the opening and closing unit is opened.

5. The control apparatus according to claim 4,
wherein the power supply unit, the submersion signal acquisition unit, the operation detection unit, and the control unit are provided in a non-submerged region.

6. The control apparatus according to claim 5,
wherein the opening and closing unit is a window or a door provided in a vehicle,
wherein the drive unit includes an opening and closing switch for the window or the door, and
wherein the control unit controls the supplying of power from the power supply unit to contact points of the opening and closing switch on a basis of the submersion signal and the operation.

7. The control apparatus according to claim 1,
wherein the control unit, on a basis of the operation detected by the operation detection unit, restarts supplying power to the drive unit and outputs to the drive unit a drive signal that drives the opening and closing unit such that the opening and closing unit is opened.

8. The control apparatus according to claim 7,
wherein the control unit restarts supplying power to the drive unit further on a basis of the submersion signal and outputs to the drive unit the drive signal for driving the opening and closing unit such that the opening and closing unit is opened.

9. The control apparatus according to claim 8,
wherein the power supply unit, the submersion signal acquisition unit, the operation detection unit, and the control unit are provided in a non-submerged region.

10. The control apparatus according to claim 9,
wherein the opening and closing unit is a window or a door provided in a vehicle,
wherein the drive unit includes an opening and closing switch for the window or the door, and
wherein the control unit controls the supplying of power from the power supply unit to contact points of the opening and closing switch on a basis of the submersion signal and the operation.

11. The control apparatus according to claim 1,
wherein the power supply unit, the submersion signal acquisition unit, the operation detection unit, and the control unit are provided in a non-submerged region.

12. The control apparatus according to claim 11,
wherein the opening and closing unit is a window or a door provided in a vehicle,
wherein the drive unit includes an opening and closing switch for the window or the door, and
wherein the control unit controls the supplying of power from the power supply unit to contact points of the opening and closing switch on a basis of the submersion signal and the operation.

13. The control apparatus according to claim 1,
wherein the opening and closing unit is a window or a door provided in a vehicle,
wherein the drive unit includes an opening and closing switch for the window or the door, and
wherein the control unit controls the supplying of power from the power supply unit to contact points of the opening and closing switch on a basis of the submersion signal and the operation.
